(19) United States
(12) Patent Application Publication
(10) Pub. No.: US 2009/0316989 A1
(43) Pub. Date: Dec. 24, 2009

(54) METHOD AND ELECTRONIC DEVICE FOR CREATING AN IMAGE COLLAGE

(75) Inventors: Mauro Barbieri, Eindhoven (NL); Johannes Weda, Eindhoven (NL); Giuseppe Gallo, Florence (IT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/440,248

(22) PCT Filed: Sep. 7, 2007
(86) PCT No.: PCT/IB2007/053604

§ 371 Date: Mar. 6, 2009

(30) Foreign Application Priority Data
Sep. 11, 2006 (EP) 06120434.3

(51) Int. Cl. G06K 9/34

(52) U.S. Cl. 382/173

(57) ABSTRACT

The method of creating an image collage of the invention comprises the steps of determining a region of interest (43) in a background image (41) and displaying at least one foreground image over the background image (41) outside the region of interest (43). The electronic device of the invention is operative to perform the method of the invention. The computer program of the invention is operative to make a programmable device perform the method of the invention.

### FIELD OF THE INVENTION

The invention relates to a method of creating an image collage.

The invention further relates to an electronic device for creating an image collage, the electronic device comprising electronic circuitry.

The invention also relates to a computer program for enabling a programmable device to perform a method of creating an image collage.

### BACKGROUND OF THE INVENTION

An example of a method for creating an image collage is described in US2005/0220345. In the method described in US2005/0220345, regions of interest are determined of a plurality of images, the plurality of images are cropped to remove uninformative parts, i.e. only the regions of interest are kept, and the plurality of cropped images are placed adjacently in a single image to form a collage. A drawback of the method described in US2005/0220345 is that the collage does not adequately convey the mood of a certain group of images.

### SUMMARY OF THE INVENTION

It is a first object of the invention to provide a method of the type described in the opening paragraph, which produces an image collage which better conveys the mood of a group of images.

It is a second object of the invention to provide a system of the type described in the opening paragraph, which produces an image collage which better conveys the mood of a group of images.

According to the invention, the first object is realized in that the method comprises the steps of determining a region of interest in a background image and displaying at least one foreground image over the background image outside the region of interest. The background image conveys the mood of a group of pictures and provides a context for the foreground image. The region of interest of the background image needs to be unobstructed in order to effectively convey the mood. The background image may represent, for example, a beach photographed from a long distance. The foreground image may represent, for example, photographed persons and/or monuments.

In an embodiment of the method, the step of displaying at least one foreground image comprises displaying a plurality of foreground images, the background image being visible between the foreground images. More information can be conveyed when displaying a plurality of foreground images, but the background image should be visible between the foreground images in order to keep conveying the mood of the group of pictures.

The step of determining the region of interest may comprise looking for high contrast parts and/or faces in the background image. High contrast parts and/or faces are generally considered important by viewers and should preferably not be obstructed by a foreground image in a background image.

The method may further comprise the step of selecting the background image by looking for an image of which the region of interest is relatively small and/or does not have an irregular shape. A background image meeting one or both of these criteria has relatively many areas over which foreground images can be displayed.

The method may further comprise the step of cropping the foreground image to remove uninformative parts. This makes the foreground image small enough to form part of the collage. Additionally or alternatively, the method may further comprise resizing the foregound image to make the foreground image small enough to form part of the collage. Cropping the foreground image may result in multiple images if the foreground image comprises multiple separate regions of interest. Each of these multiple separate regions of interest may be displayed independently over the background image.

The method may further comprise the step of replacing the foreground image with a further foreground image at a rate which is higher than a rate at which the background image is replaced with a further background image. This results in a dynamic image collage in which persons or monuments can be displayed sequentially over a background image representative of the location at which the photographs of the persons or monuments were taken, for example.

A duration during which the foreground image is displayed may depend on a rating of the foreground image. In this way, the most important subjects and objects become most noticeable in the dynamic photo collage.

The dynamic collage can be made interactive by allowing users to select foreground objects, e.g. by means of mouse click, or touch. The content item to which the foreground object belongs is then shown enlarged or selected as background image. In this way, the dynamic collage can be used not only as a visually appealing representation of a content collection, but also as a browsing tool.

According to the invention, the second object is realized in that the electronic circuitry of the electronic device is operative to determine a region of interest in a background image and display at least one foreground image over the background image outside the region of interest. The electronic device may be a portable device, such as a photo-enabled mp3-player, a mobile phone, a digital still camera or a PDA, or a stationary device, such as a personal computer, a HDD recorders or a television set. The electronic device may be a home computer or a server computer, e.g. for providing overviews of content collections in online services such as photo/video sharing and backup services, video on demand and media online shops.

### BRIEF DESCRIPTION OF THE DRAWINGS

These and other aspects of the invention are apparent from and will be further elucidated, by way of example, with reference to the drawings, in which:

FIG. 1 is a flow chart of the method of the invention;

FIG. 2 is a flow chart of an embodiment of the method of the invention;

FIG. 3 shows four examples of detection of region of interest based on contrast;

FIG. 4 shows a fifth example of a detected region of interest in a background image;

FIG. 5 shows areas in the background image of FIG. 4 to potentially put a foreground image in;

FIG. 6 is a block diagram of the electronic device of the invention.

Corresponding elements in the drawings are denoted by the same reference numeral.

### DETAILED DESCRIPTION OF THE DRAWINGS

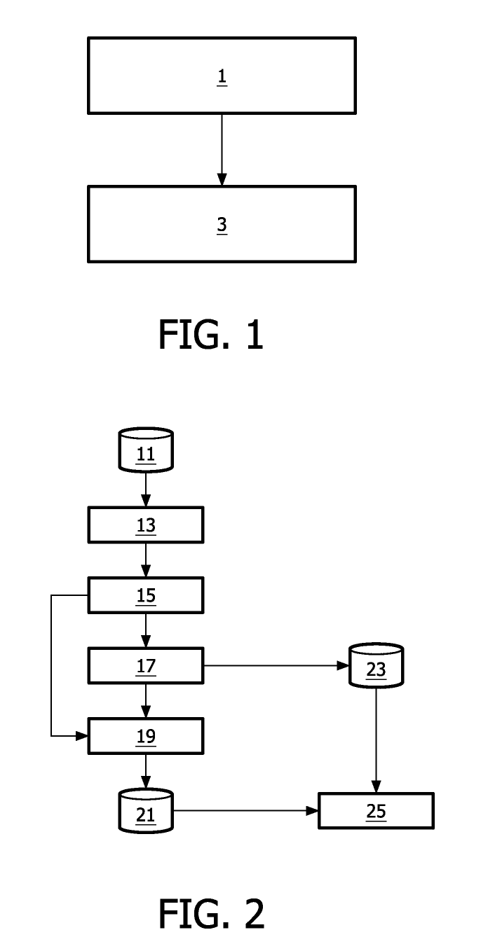

The method of the invention comprises a step 1 of determining a region of interest in a background image and a step 3 of displaying at least one foreground image over the background image outside the region of interest, see FIG. 1.

In an embodiment of the method, see FIG. 2, a plurality of images 11 serves as input. The plurality of images 11 can be a directory of a content collection of photos, or key frames extracted from video, for example.

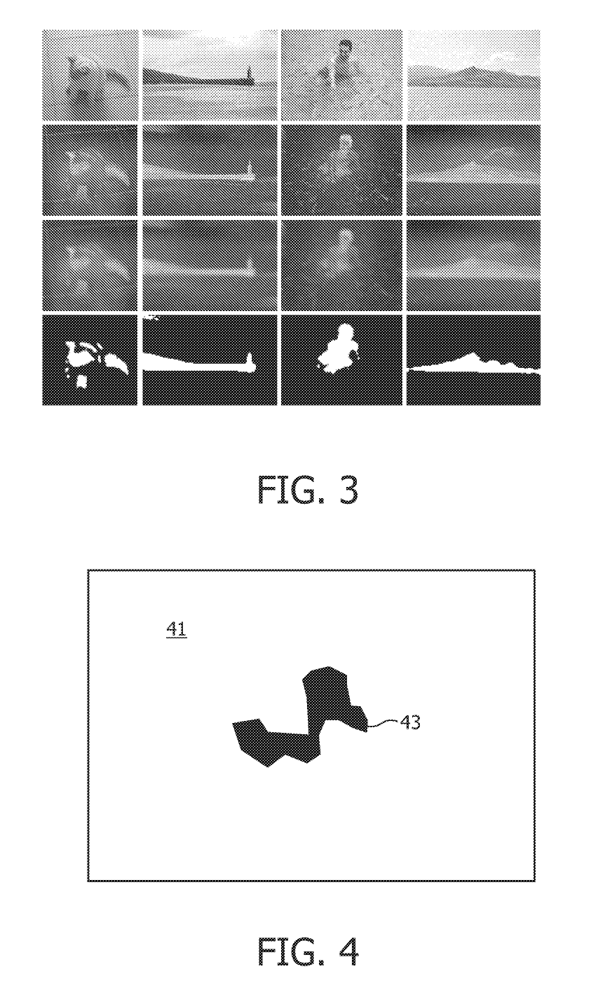

Step 13 comprises determining regions of interest in the plurality of images 11. The objects and elements in a still picture can be divided into two categories: (1) an interesting part, which is usually the subject of the pictures, such as faces, people and monuments (2) a boring or uninteresting parts, which usually serve as the background of the picture, such as sky, wall of a building room, and grass. The first category is defined as a region of interest. Humans' attention is captured by high contrast parts of an image and by faces (additionally, for video, motion plays an important role). These regions are selected in step 15 by looking for high contrast areas in the image. An example of this procedure is shown in FIG. 3. Optionally, face detection can also be performed to make sure that faces are included in the region of interest.

Step 17 comprises determining suitable background images. To convey as much information as possible in the photo collage, the collage is composed out of a background image with embedded foreground images. However, the regions of the images should not overlap, or be occluded. Therefore, the region of interest detected in the previous step is analysed to determine its size and shape. When the region of interest is big with respect to the original shape, or when the region of interest has an irregular shape, the corresponding image is not well suited to be a background image. The size of the region can be calculated by summing the number of pixels belonging to the region of interest. Alternatively, the size of the smallest rectangle containing the whole region of interest can be determined. The ratio of these two methods is one of the possible measures of the irregularity of the region of interest. This ratio can also be taken into account in the search for suitable background images. In this way, the images are divided into foreground images 21 and background images 23. Additionally, other visual features (e.g. number of edges, image complexity, texture) can be taken into consideration.

Step 19 comprises cropping the foreground images. The foreground images should only be objects or elements that are useful and informative. Therefore, the foreground images have to be cropped to remove uninformative parts. The cropping is done based on the region of interest. The smallest rectangle containing the whole region of interest can be used for this purpose. Additionally, the region of interest can be considered as consisting of several connected sub-regions, which are individually analysed on size and shape. Subsequently, these sub-regions can be merged or neglected in the process of cropping the foreground images.

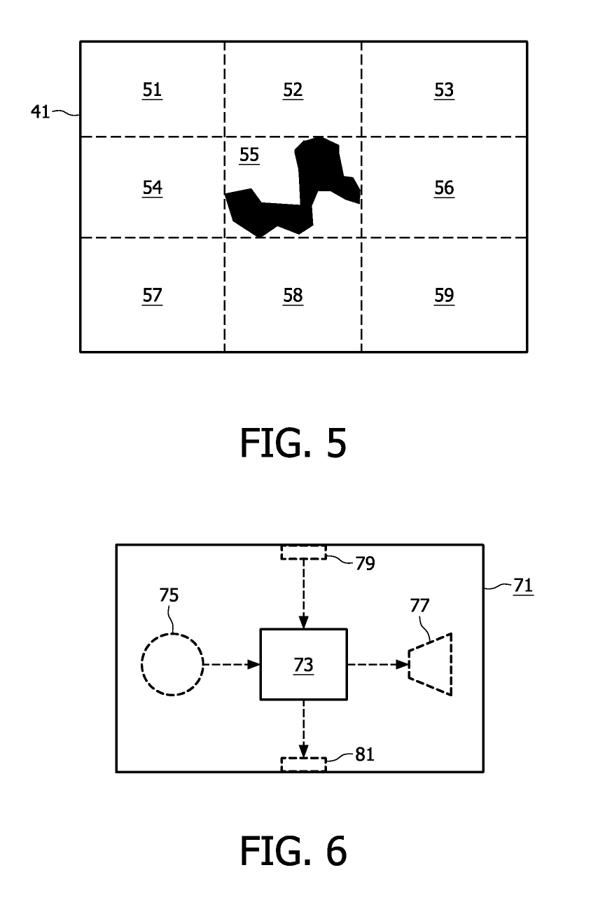

Step 25 comprises composing the collage. From the previous steps, two sets of (cropped) images are obtained: foreground images 21 and background images 23. In the composition of the image collage, the foreground images are smartly positioned in the background image. This means that they do not overlap with each other and do not occlude the background region of interest. The problem of finding the positions and size of each foreground image can be mapped to a constrained optimisation problem (2D bin-packing) in which the non-overlapping and non-occluding conditions are modelled using the separating axis theorem, a known technique used in computer games. The variables of the problem are position and size of each foreground image. The size variables are lower bounded by minimum sizes that can depend on the content of the foreground images. The constraints are: non-overlapping between foreground images and non-occlusion of the background. An additional constraint may be to leave sufficient parts of the background image free (e.g. by adding an empty border around the foregound images). The objective functions to maximize are the number of foreground images and their areas in number of pixels. A solution to the 2D bin-packing problem is then found with standard methods. Some of the conditions can be relaxed to allow partial overlapping/occlusion when the 2D bin-packing program does not find a feasibile solution. The ‘best’ solution (the one with minimum overlap) can then be accepted. FIGS. 4 and 5 show the case in which a region of interest is modelled with its bounding box (smallest rectangle containing the box). FIG. 4 shows the original image 41 with detected region of interest 43. FIG. 5 shows areas to put a foreground image in: areas 51-54 and 56-59 and forbidden areas: 55.

The steps above describe in details how to automatically construct a static collage. However, a static collage can only show a rather limited number of images, which gives a rather restricted overview of the collection. Animating the collage by dynamically changing the foreground images and the background images in time can solve this. For visual continuity, the foreground images are changed faster than the background image. The change in time of the collage complicated the positioning of the foreground images. The 2D bin-packing problem is transformed from a two-dimensional problem to a three-dimensional problem (2 space dimensions on the background image and 1 time dimension). Since the region of interest is not the same in every background image, the size of the available space varies, thus constituting dynamic boundary conditions. The separating axis theorem can be applied also to the 3D bin-packing problem and a solution can again be found with standard methods. If the problem is overconstrained (no solution without overlap exists), then the solution with the smallest (and shortest) amount over overlap could be chosen. Additionally, the relative importance (rating) of the content items can be taken into consideration in the optimisation procedure so as to show important images sooner and/or for a longer time than less important foreground images. The importance/rating could be determined, for example, based on the size of the ROI, on annotations, manual rating, number of times the images have been seen.

Electronic device 71 of FIG. 6 is an electronic device for creating an image collage. The electronic circuitry 73 of the electronic device 71 is operative to determine a region of interest in a background image and display at least one foreground image over the background image outside the region of interest. The electronic device 71 may further comprise a storage means 75, a reproduction means 77, an input 79 and/or an output 81. The electronic device 71 may be a stationary or a portable device. The electronic device 71 may be a consumer device or a professional device. The electronic circuitry 73 may be a general-purpose or an application-specific processor. The electronic circuitry 73 may be capable of executing a computer program.

The storage means 75 may comprise, for example, a hard disk, solid-state memory, an optical disc reader or a holographic storage means. The storage means 75 may store the foreground and/or background images and/or the image collage. The reproduction means 77 may comprise, for example, a display and/or a loud speaker. The reproduction means 77 may be used display the image collage. Alternatively, the output 81 may be used to display the image collage on an external display (not shown). The electronic device 71 may comprise an input means (not shown), e.g. a touch screen or a touch pad. Alternatively, the input 79 may be used to receive user input from an external input device (not shown). The external input device may be a mouse, a trackball or a digital pen, for example. The input 79 and output 81 may comprise, for example, a network connector, e.g. a USB connecter or an Ethernet connector, an analog audio and/or video connector, such as a cinch connector or a SCART connector, or a digital audio and/or video connector, such as an HDMI or SPDIF connector. The input 79 and output 81 may comprise a wireless receiver and/or transmitter.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the device claim enumerating several means, several of these means can be embodied by one and the same item of hardware. ‘Computer program’ is to be understood to mean any software product stored on a computer-readable medium, such as a floppy disk, downloadable via a network, such as the Internet, or marketable in any other manner.

1. A method of creating an image collage, the method comprising the steps of:
determining (1) a region of interest (43) in a background image (41); and
displaying (3) at least one foreground image over the background image (41) outside the region of interest (43).

2. A method as claimed in claim 1, wherein the step of displaying (3) at least one foreground image comprises displaying a plurality of foreground images, the background image (41) being visible between the foreground images.

3. A method as claimed in claim 1, wherein the step of determining (1) the region of interest (43) comprises looking for high contrast parts and/or faces in the background image (41).

4. A method as claimed in claim 1, further comprising the step of selecting the background image (41) by looking for an image of which the region of interest (43) is relatively small and/or does not have an irregular shape.

5. A method as claimed in claim 1, further comprising the step of cropping the foreground image to remove uninformative parts.

6. A method as claimed in claim 1, further comprising the step of resizing the foreground image.

7. A method as claimed in claim 1, further comprising the step of replacing the foreground image with a further foreground image at a rate which is higher than a rate at which the background image (41) is replaced with a further background image.

8. A method as claimed in claim 7, wherein a duration during which the foreground image is displayed depends on a rating of the foreground image.

9. A computer program for enabling a programmable device to perform the method of claim 1.

10. An electronic device (71) for creating an image collage, comprising electronic circuitry (73), the electronic circuitry (73) being operative to:
determine a region of interest (43) in a background image (41); and
display at least one foreground image over the background image (41) outside the region of interest (43).
